(19) United States
(12) Patent Application Publication
(10) Pub. No.: US 2024/0254286 A1
(43) Pub. Date: Aug. 1, 2024

(54) POLYESTERIMIDE RESIN COMPOSITION, POLYESTERIMIDE RESIN LAYER, FLEXIBLE METAL FOIL LAMINATE, AND METHODS OF PREPARING THE SAME

(71) Applicant: NexFlex Co., Ltd., Chungcheongbuk-do (KR)

(72) Inventors: Hyuk Jun KIM, Daejeon (KR); Dae Nyoun KIM, Daejeon (KR); Yun Jeong JO, Daejeon (KR); Ki Hoon KIM, Sejong-si (KR); Ra Mi LEE, Daejeon (KR)

(73) Assignee: NexFlex Co., Ltd., Chungcheongbuk-do (KR)

(21) Appl. No.: 18/534,022

(22) Filed: Dec. 8, 2023

(30) Foreign Application Priority Data
Jan. 19, 2023 (KR) 10-2023-0007820

(51) Int. Cl. C08G 73/16; B32B 15/08; B32B 15/20; B32B 27/08; C08G 73/10

(52) U.S. Cl. CPC C08G 73/16; B32B 15/08; B32B 15/20; B32B 27/08; C08G 73/1067; B32B 2250/02; B32B 2250/03; B32B 2250/04; B32B 2250/05; B32B 2307/204; B32B 2311/12; B32B 2379/08; B32B 2457/08

(57) ABSTRACT

A polyesterimide resin composition, a polyesterimide resin layer, a flexible metal foil laminate, and methods of preparing the polyesterimide resin composition, the polyesterimide resin layer, and the flexible metal foil laminate are provided. The polyesterimide resin composition includes a compound having a structural unit represented by Chemical Formula 1:

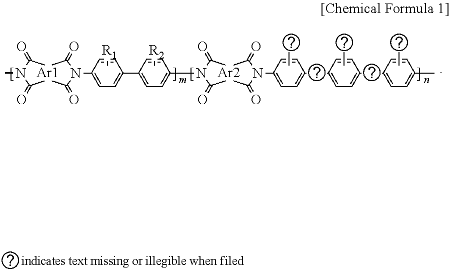

In Chemical Formula 1, m and n are mole fractions, and “m+n=1” “0.2≤m≤0.8” and “0.2≤n≤0.8” are satisfied. Ar1 and Ar2 are the same as or different from each other and are each independently a tetravalent organic group having at least one aromatic ring. R₁, R₂, and R₄ to R₆ each independently include at least one of —H, —F, —CH₃, —OCH₃, —CF₃, and —OCF₃. R₃ is an ester group and includes —COO— or —OOC—.

### CROSS-REFERENCE TO RELATED APPLICATION

This application claims the benefit of Korean Patent Application No. 10-2023-0007820 filed on Jan. 19, 2023, in the Korean Intellectual Property Office, the entire disclosure of which is incorporated herein by reference for all purposes.

### BACKGROUND

### 1. Field of the Invention

One or more embodiments relate to a polyesterimide resin composition, a polyesterimide resin layer, a flexible metal foil laminate, and methods of preparing the polyesterimide resin composition, the polyesterimide resin layer, the flexible metal foil laminate.

### 2. Description of the Related Art

Recently, with the trend of high performance and high functions of portable wireless communication devices such as smartphones, the signal transmission volume and rate are increasing. In particular, with the commercialization of fifth-generation wireless communication devices (5G NR), the use of gigahertz (GHz) band communication frequencies is becoming more common. If a communication frequency increases, a signal loss through a circuit increases. To overcome the signal loss, a dielectric loss tangent of an insulating material needs to be reduced. In addition, since a phenomenon in which the dielectric loss tangent increases due to absorption of moisture in the air occurs when a moisture absorption rate of the insulating material is high, lowering the moisture absorption rate of the insulating material is important.

Recently, liquid crystalline polymers and fluorine-based polymers have received increasing attention as insulating resins to reduce a signal loss in a high frequency band. The liquid crystalline polymers and fluorine-based polymers may reduce a loss of a signal due to their low dielectric loss tangents and low moisture absorption rates in the air. For example, Korean Patent Application No. 10-2022-0015562A discloses an insulator having liquid crystal polymers formed on both sides of a polyimide film, and a flexible metal foil laminate using the insulator.

Generally, a polyimide-based resin is used as an insulating layer of a flexible metal foil laminate. The polyimide-based resin is excellent in heat resistance, chemical resistance, and low thermal expansion, and has excellent processing characteristics, in particular, during manufacturing of circuits.

On the other hand, liquid crystalline polymers and fluorine-based polymers have excellent electrical properties, but actual use thereof in industrial fields is significantly limited due to a lack of processing characteristics during manufacturing of circuits.

### SUMMARY

One or more embodiments provide a polyesterimide resin composition, a polyesterimide resin layer, and a flexible metal foil laminate, as an insulating material for a circuit board with a low signal loss, an enhanced dielectric loss tangent and an enhanced moisture absorption rate while maintaining excellent processing characteristics of a polyimide-based resin, and provide methods of preparing the polyesterimide resin composition, the polyesterimide resin layer, and the flexible metal foil laminate.

However, the technical goal obtainable from the present disclosure is not limited to those described above, and other goals not mentioned above can be clearly understood by one of ordinary skill in the art to which the present disclosure pertains from the following description.

According to an aspect, there is provided a polyesterimide resin composition including a compound having a structural unit represented by Chemical Formula 1:

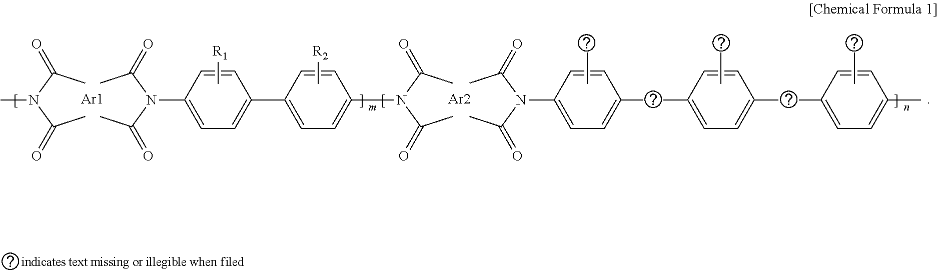

In Chemical Formula 1, m and n are mole fractions, and “m+n=1”, “0.2≤m≤0.8”, and “0.2≤n≤0.8” are satisfied. Ar1 and Ar2 are the same as or different from each other and are each independently a tetravalent organic group having at least one aromatic ring. R₁, R₂, and R₄ to R₆ each independently include at least one of —H, —F, —CH₃, —OCH₃, —CF₃, and —OCF₃. R₃ is an ester group and includes —COO— or —OOC—.

In an embodiment, the structural unit represented by Chemical Formula 1 may be present as a block copolymer or a random copolymer.

In an embodiment, a resin represented by Chemical Formula 1 may be prepared by, for example, preparing a polyamic acid through a reaction between diamine and dianhydride and converting the polyamic acid to a polyetherimide resin via thermal or chemical conversion, or a polyesterimide resin may be prepared through a direct reaction between dianhydride and diisocyanate.

In an embodiment, Chemical Formula 1 may include Chemical Formula 2:

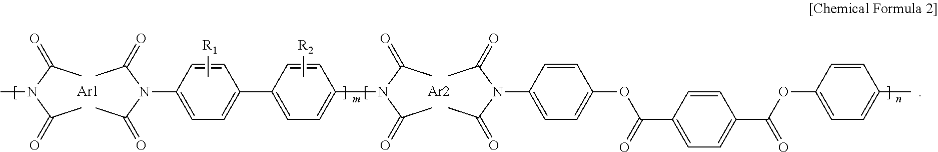

In an embodiment, Ar1 and Ar2 in Chemical Formula 1 may include a compound having a structural unit represented by Chemical Formula 3:

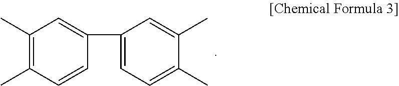

In an embodiment, the compound having the structural unit represented by Chemical Formula 3 may include at least 50 mol % of Ar1 and Ar2 in Chemical Formula 1.

According to another aspect, there is provided a polyesterimide resin layer including a polyesterimide resin composition according to an embodiment.

In an embodiment, the polyesterimide resin layer may have a moisture absorption rate of 0.5% or less measured at 23° C. and 50% relative humidity (RH).

In an embodiment, the polyesterimide resin layer may have a dielectric loss tangent of “0.0035” or less at 10 gigahertz (GHz) measured at 23° C. and 50% RH.

In an embodiment, the polyesterimide resin layer may have a coefficient of linear thermal expansion of 50 parts per million per Kelvin (ppm/K) or less measured at a temperature between 100° C. and 250° C.

According to another aspect, there is provided a flexible metal foil laminate including at least one insulating layer, and a metal layer formed on one surface or both surfaces of the insulating layer. The insulating layer may include a polyesterimide resin layer according to an embodiment.

In an embodiment, the insulating layer may further include at least one thermoplastic polyimide-based resin layer. The thermoplastic polyimide-based resin layer may include a compound including an imide group represented by Chemical Formula 4:

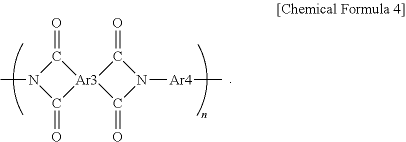

In Chemical Formula 4, Ar3 is a tetravalent organic group having at least one aromatic ring in a structure of Ar3, and Ar4 is an organic group having at least one aromatic ring in a structure of Ar4.

In an embodiment, a storage modulus of the thermoplastic polyimide-based resin layer measured at 350° C. may be 1.0×10⁸ Pa or less, and a difference in a coefficient of thermal expansion, measured at a temperature between 100° C. and 380° C., between the polyesterimide resin layer and the thermoplastic polyimide-based resin layer may be 100 ppm/K or less.

In an embodiment, a surface roughness Rz of the metal layer in contact with the insulating layer may be less than or equal to 1.5 micrometers (m), and a bonding strength between the metal layer and the insulating layer may be greater than or equal to 0.8 kilogram force per centimeter (kgf/cm).

According to another aspect, there is provided a method of preparing a polyesterimide resin composition, the method including preparing a polyamic acid through a reaction between a diamine and a dianhydride, and thermally or chemically converting the polyamic acid. The polyesterimide resin composition may include a compound having a structural unit represented by Chemical Formula 1:

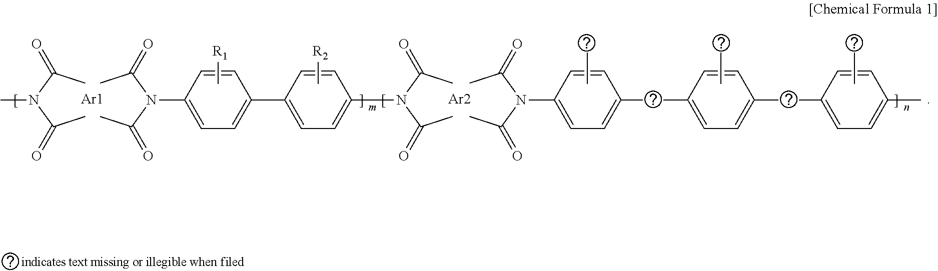

In Chemical Formula 1, m and n are mole fractions, and “m+n=1”, “0.2≤m≤0.8”, and “0.2≤n≤0.8” are satisfied. Ar1 and Ar2 are the same as or different from each other and are each independently a tetravalent organic group having at least one aromatic ring. R₁, R₂, and R₄ to R₆ each independently include at least one of —H, —F, —CH₃, —OCH₃, —CF₃, and —OCF₃. R₃ is an ester group and includes —COO— or —OOC—.

In an embodiment, the preparing of the polyamic acid may include dissolving the diamine in an organic solvent or dispersing the diamine in the form of slurry in an inert atmosphere, and adding the dianhydride that is dissolved in the organic solvent or dispersed in the form of slurry or adding the dianhydride in a solid state.

In an embodiment, the diamine may include at least one of 4,4′-diamino-3,3′-dimethylbiphenyl (o-tolidine, CAS No. 119-93-7), 4,4′-diamino-2,2′-dimethylbiphenyl (m-tolidine, CAS No. 84-67-3), 2,2′-bis(trifluoromethyl)benzidine (22TFMB, CAS No. 341-58-2), 3,3′-bis(trifluoromethyl)benzidine (33TFMB, CAS No. 346-88-3), 1,4-phenylene-di-4-aminobenzoate (ABHQ, CAS No. 22095-98-3), and bis(4-aminophenyl)terephthalate (BPTP, CAS No. 16926-73-1).

According to another aspect, there is provided a method of preparing a polyesterimide resin composition, the method including directly reacting a dianhydride with diisocyanate. The polyesterimide resin composition may include a compound having a structural unit represented by Chemical Formula 1:

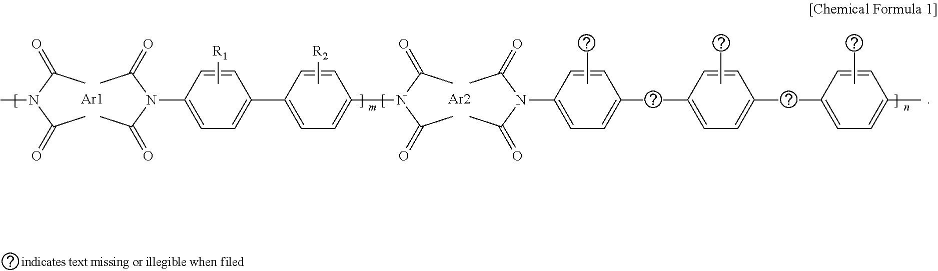

In Chemical Formula 1, m and n are mole fractions, and “m+n=1”, “0.2≤m≤0.8”, and “0.2≤n≤0.8” are satisfied. Ar1 and Ar2 are the same as or different from each other and are each independently a tetravalent organic group having at least one aromatic ring. R₁, R₂, and R₄ to R₆ each independently include at least one of —H, —F, —CH₃, —OCH₃, —CF₃, and —OCF₃. R₃ is an ester group and includes —COO— or —OOC—.

In an embodiment, the dianhydride may include at least one of: an aliphatic or alicyclic tetracarboxylic dianhydride including at least one of 2,2′-hexafluoropropylidene diphthalic dianhydride, 2,2-bis(4-hydroxyphenyl)propane dibenzoate-3,3′,4,4′-tetracarboxylic dianhydride, butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofuran tetracarboxylic dianhydride, 5-(2,5-dioxotetrahydrofural)-3-methyl-3-cyclohexene-1,2-dicarboxylic dianhydride, and bicyclo[2,2,2]-oct-7-ene-2,3,5,6-tetracarboxylic dianhydride; and at least one aromatic tetracarboxylic dianhydride among pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′,4,4′-biphenyl ether tetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bisphenol A dianhydride, 3,3′,4,4′-perfluoroisopropylidenediphthalic dianhydride, 3,3′,4,4′-biphenyltetracarboxylic dianhydride, bis(phthalic acid)phenylphosphine oxide dianhydride, p-phenylene-bis(triphenyl phthalic) dianhydride, m-phenylene-bis(triphenyl phthalic) dianhydride, bis(triphenyl phthalic)-4,4′-diphenyl ether dianhydride, 3,3′,4,4′-benzophenonetetracarboxylic dianhydride, and bis(triphenyl phthalic)-4,4′-diphenylmethane dianhydride.

According to another aspect, there is provided a method of preparing a polyesterimide film, the method including applying a polyamic acid-based resin composition convertible into a polyesterimide resin onto a metal belt, forming a gel film by thermally or chemically imidizing the polyamic acid-based resin composition, and separating the gel film from the metal belt.

According to another aspect, there is provided a method of preparing a flexible metal foil laminate, the method including sequentially applying polyamic acid-based resin layers, which are respectively convertible into a thermoplastic polyimide-based resin layer, a non-thermoplastic polyimide-based resin layer, and a thermoplastic polyimide-based resin layer, onto a metal layer, and performing imidization by thermally or chemically converting the polyamic acid-based resin layers.

According to another aspect, there is provided a method of preparing a flexible metal foil laminate, the method including preparing a multilayer polyimide film including a multilayer structure formed by a thermoplastic polyimide-based resin layer, a non-thermoplastic polyimide-based resin layer, and a thermoplastic polyimide-based resin layer, and laminating a metal layer on one surface or both surfaces of the multilayer polyimide film.

According to embodiments, a polyesterimide resin composition and a polyesterimide resin layer may have low moisture absorption, low thermal expansion, and low dielectric loss tangent. The polyesterimide resin layer may be used as an insulating layer in a flexible metal foil-laminated film.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a cross-sectional view of an example of a single-sided flexible metal foil laminate according to an embodiment;

FIG. 2 is a cross-sectional view of an example of a double-sided flexible metal foil laminate according to an embodiment;

FIG. 3 is a cross-sectional view of another example of a single-sided flexible metal foil laminate according to an embodiment;

FIG. 4 is a cross-sectional view of another example of a single-sided flexible metal foil laminate according to an embodiment;

FIG. 5 is a cross-sectional view of another example of a double-sided flexible metal foil laminate according to an embodiment;

FIG. 6 is a cross-sectional view of another example of a double-sided flexible metal foil laminate according to an embodiment;

FIG. 7 is a diagram illustrating an example of a method of preparing a flexible metal foil laminate according to an embodiment;

FIG. 8 is a drawing illustrating another example of a method of preparing a flexible metal foil laminate according to an embodiment; and

FIG. 9 is a drawing illustrating another example of a method of preparing a flexible metal foil laminate according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or combinations thereof, but do not preclude the presence or addition of one or more of other features, integers, steps, operations, elements, components, or combinations thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the embodiments.

In addition, terms such as first, second, A, B, (a), (b), and the like may be used to describe components of the embodiments. These terms are used only for the purpose of discriminating one component from another component, and the nature, the sequences, or the orders of the components are not limited by the terms.

The same name may be used to describe an element included in the embodiments described above and an element having a common function. Unless otherwise mentioned, the descriptions on the embodiments may be applicable to the following embodiments and thus, duplicated descriptions will be omitted for conciseness.

Hereinafter, a polyesterimide resin composition, a polyesterimide resin layer, a flexible metal foil laminate, and methods of preparing the polyesterimide resin composition, the polyesterimide resin layer, and the flexible metal foil laminate according to embodiments will be described in detail with reference to embodiments, preparation examples, and drawings. However, the present disclosure is not limited to the embodiments, preparation examples, and drawings.

According to an embodiment, a polyesterimide resin composition may include a compound having a structural unit represented by Chemical formula 1:

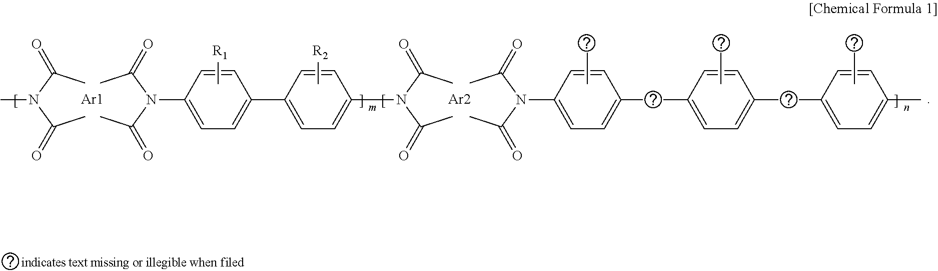

In Chemical Formula 1, m and n are mole fractions, and “m+n=1”, “0.2≤m≤0.8” and “0.2≤n≤0.8” are satisfied. Ar1 and Ar2 are the same as or different from each other and are each independently a tetravalent organic group having at least one aromatic ring. R₁, R₂, and R₄ to R₆ each independently include at least one of —H, —F, —CH₃, —OCH₃, —CF₃, and —OCF₃. R₃ is an ester group and includes —COO— or —OOC—.

In an embodiment, m and n in Chemical Formula 1 are mole fractions, and “m+n=1”, “0.2≤m≤0.8”, and “0.2≤n≤0.8” may be satisfied. A polyesterimide resin according to an embodiment may achieve expected physical properties by copolymerization of m and n. If m and n are less than “0.2” or exceed “0.8”, properties such as a moisture absorption rate and a dielectric loss tangent may be reduced, or film formation properties required as a film may lack. Specifically, if m is less than “0.2” or n exceeds “0.8” in Chemical Formula 1, a film may be easily broken due to a lack of flexibility of the film, which may result in a lack of film formation properties. In addition, if m exceeds “0.8” or n is less than “0.2”, the dielectric loss tangent may exceed “0.0035”, or the moisture absorption rate may exceed 0.5%, which may cause a problem.

In an embodiment, the structural unit represented by Chemical Formula 1 may be present as a block copolymer or a random copolymer.

The polyesterimide resin may achieve desired physical properties by copolymerization of structural units represented by Chemical Formula 1. Here, a copolymer may be present as a block copolymer or a random copolymer.

In an embodiment, the compound having a structural unit represented by Chemical Formula 1 may include at least 80 mol % of the polyesterimide resin layer.

If the amount of the compound having a structural unit represented by Chemical Formula 1 is less than 80 mol % of the polyesterimide resin layer, the dielectric loss tangent may increase and other properties such as a coefficient of thermal expansion or a moisture absorption rate may decrease. Accordingly, the amount in the above range may need to be maintained.

In an embodiment, Chemical Formula 1 may include Chemical Formula 2:

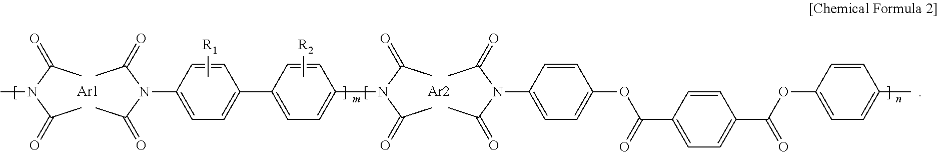

Chemical Formula 2 may include bis(4-aminophenyl)terephthalate (BPTP), because R₃ in Chemical Formula 1 is an ester-containing diamine monomer.

In an embodiment, Chemical Formula 1 may include Chemical Formula 2-1:

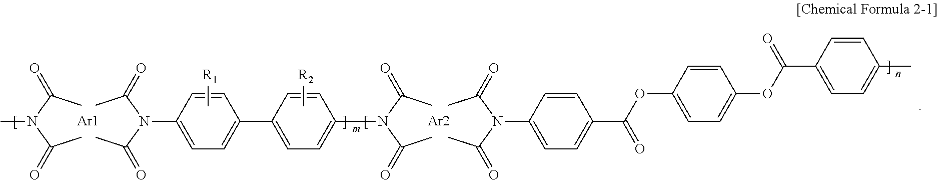

Chemical Formula 2-1 may include 1,4-bis(4-aminobenzo-yloxy)benzene (ABHQ), because R₃ in Chemical Formula 1 is an ester-containing diamine monomer.

In an embodiment, Ar1 and Ar2 in Chemical Formula 1 may include a compound having a structural unit represented by Chemical Formula 3:

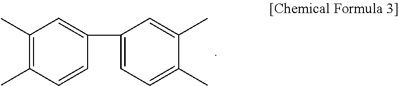

In an embodiment, the compound having the structural unit represented by Chemical Formula 3 may include at least 50 mol % of Ar1 and Ar2 in Chemical Formula 1.

In an embodiment, if a mole fraction of a structure of Chemical Formula 3 with respect to the total mole fraction of Ar1 and Ar2 in Chemical Formula 1 is denoted by p, “0.5≤p≤1.0” may be satisfied.

In an embodiment, the dielectric loss tangent and the moisture absorption rate of all insulating layers, and a signal loss of a circuit may be additionally enhanced by introducing structures of Chemical Formulae 2 and 2-1 in components of Chemical Formula 1.

According to an embodiment, a polyesterimide resin layer may include a polyesterimide resin composition according to an embodiment.

The polyesterimide resin composition may include a compound having a structural unit represented by Chemical formula 1:

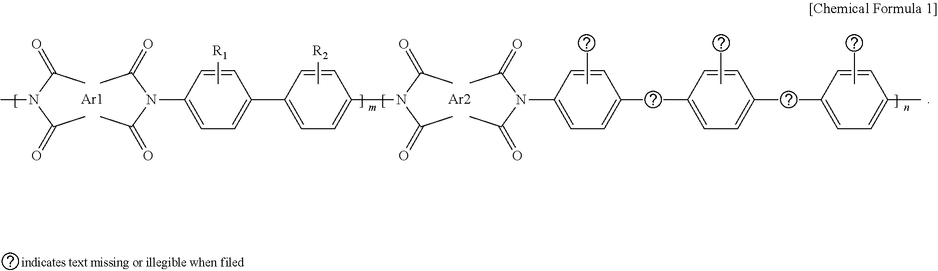

In Chemical Formula 1, m and n are mole fractions, and “m+n=1”, “0.2≤m≤0.8”, and “0.2≤n≤0.8” are satisfied. Ar1 and Ar2 are the same as or different from each other and are each independently a tetravalent organic group having at least one aromatic ring. R₁, R₂, and R₄ to R₆ each independently include at least one of —H, —F, —CH₃, —OCH₃, —CF₃, and —OCF₃. R₃ is an ester group and includes —COO— or —OOC—.

In an embodiment, Chemical Formula 1 may include Chemical Formula 2:

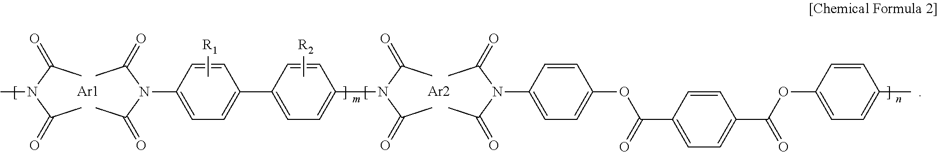

In an embodiment, Ar1 and Ar2 in Chemical Formula 1 may include a compound having a structural unit represented by Chemical Formula 3:

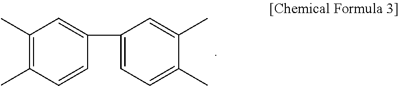

In an embodiment, the compound having the structural unit represented by Chemical Formula 3 may include at least 50 mol % of Ar1 and Ar2 in Chemical Formula 1.

In an embodiment, the moisture absorption rate measured at 23° C. and 50% relative humidity (RH) may be 0.5% or less.

To achieve a low dielectric loss tangent and low moisture absorption rate pursued in the present disclosure, the structure of Chemical Formula 3 may essentially need to be introduced in the structure of Chemical Formula 1 in the polyesterimide resin layer. When the mole fraction p of the structure of Chemical Formula 3 with respect to the total mole fraction of Ar1 and Ar2 is less than “0.5”, the moisture absorption rate measured at 23° C. and 50% RH may exceed 0.5%, or the dielectric loss tangent at 10 GHz measured at 23° C. and 50% RH may exceed “0.0035”. However, structures other than Chemical Formula 3 may be used in a range of 50 mol % or less within a range necessary to adjust physical properties such as a coefficient of thermal expansion of a resin or a film.

In an embodiment, the dielectric loss tangent at 10 GHz measured at 23° C. and 50% RH may be “0.0035” or less.

A dielectric loss tangent of an insulating layer of a flexible metal foil laminate may be affected by moisture absorbed by the insulating layer as well as a dielectric loss tangent of a material itself. Since moisture has a relatively high dielectric loss tangent, maintaining moisture absorption of the insulating layer below a predetermined level may be considered to be important to reduce a signal transmission loss in the flexible metal foil laminate.

To maintain the dielectric loss tangent of “0.0035” or less at 10 GHz measured at 23° C. and 50% RH, the moisture absorption rate of the polyesterimide resin or the polyesterimide resin layer, measured at 23° C. and 50% RH, may need to be 0.5% or less.

In an embodiment, a coefficient of linear thermal expansion measured at a temperature between 100° C. and 250° C. may be 50 parts per million per Kelvin (ppm/K) or less. If a coefficient of linear thermal expansion of the polyesterimide resin based on the structure of Chemical Formula 1 exceeds 50 ppm/K, an excessively high coefficient of linear thermal expansion of the insulating layer may have an adverse influence on a variation in a size of the flexible metal foil laminate.

In an embodiment, the polyesterimide resin layer may be used by mixing different types of resins or inorganic particles.

In an embodiment, different types of miscible resins may include, for example, an imide-based resin, an amide-imide-based resin, different types of ester-imide-based resins, a siloxane-imide-based resin, a polysiloxane resin, an epoxy resin, an acrylic resin, or a fluorine-based resin such as a perfluoroalkoxy resin, and a tetrafluoroethylene resin.

In an embodiment, miscible inorganic particles may include at least one of silica, talc, barium titanate, titanium dioxide, and calcium titanate.

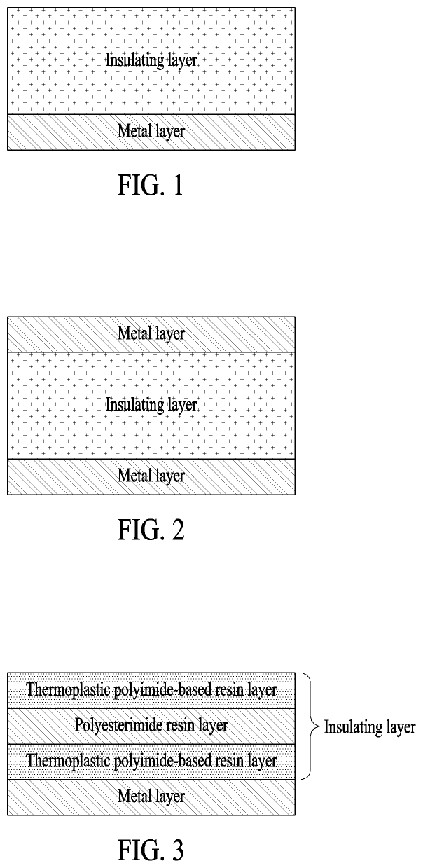

According to an embodiment, a flexible metal foil laminate may include at least one insulating layer, and a metal layer formed on one surface or both surfaces of the insulating layer. The insulating layer may include a polyesterimide resin layer according to an embodiment. FIG. 1 is a cross-sectional view of an example of a single-sided flexible metal foil laminate according to an embodiment, and FIG. 2 is a cross-sectional view of an example of a double-sided flexible metal foil laminate according to an embodiment.

Referring to FIG. 1, the single-sided flexible metal foil laminate may include an insulating layer, and a metal layer.

Referring to FIG. 2, the double-sided flexible metal foil laminate may include a metal layer, an insulating layer, and a metal layer.

In an embodiment, the insulating layer may further include at least one thermoplastic polyimide-based resin layer.

In an embodiment, the thermoplastic polyimide-based resin layer may include a compound including an imide group represented by Chemical Formula 4:

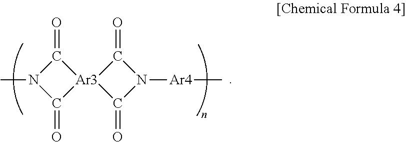

In Chemical Formula 4, Ar3 is a tetravalent organic group having at least one aromatic ring in a structure of Ar3, and Ar4 is an organic group having at least one aromatic ring in a structure of Ar4.

In an embodiment, an insulating layer of a flexible metal foil laminate may be formed by stacking different types of films. For example, an insulating layer, in which a thermoplastic polyimide resin layer, a polyesterimide resin layer, and a thermoplastic polyimide resin layer are stacked, may be used. In this example, the thermoplastic polyimide resin layer may typically have good flow properties at a high temperature.

In addition, each of the above resin layers may have a thickness of about 1 micrometer (m) to about 200 m, however, the thickness is not particularly limited.

FIG. 3 is a cross-sectional view of another example of a single-sided flexible metal foil laminate according to an embodiment.

Referring to FIG. 3, a metal layer may be formed on one surface of an insulating layer. The insulating layer may include a thermoplastic polyimide-based resin layer, a polyesterimide-based resin layer, and a thermoplastic polyimide-based resin layer.

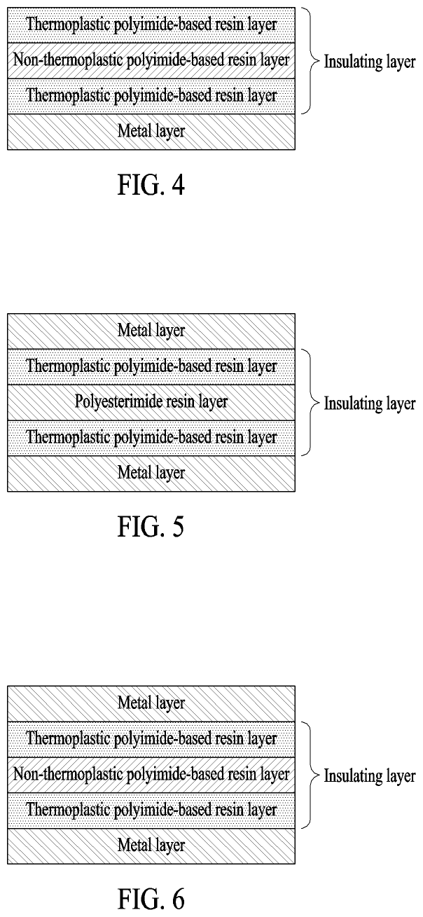

FIG. 4 is a cross-sectional view of another example of a single-sided flexible metal foil laminate according to an embodiment.

Referring to FIG. 4, a metal layer may be formed on one surface of an insulating layer. The insulating layer may include a thermoplastic polyimide-based resin layer, a non-thermoplastic polyimide-based resin layer, and a thermoplastic polyimide-based resin layer.

FIG. 5 is a cross-sectional view of another example of a double-sided flexible metal foil laminate according to an embodiment.

Referring to FIG. 5, a metal layer may be formed on both surfaces of an insulating layer. The insulating layer may include a thermoplastic polyimide-based resin layer, a polyesterimide-based resin layer, and a thermoplastic polyimide-based resin layer.

FIG. 6 is a cross-sectional view of another example of a double-sided flexible metal foil laminate according to an embodiment.

Referring to FIG. 6, a metal layer may be formed on both surfaces of an insulating layer. The insulating layer may include a thermoplastic polyimide-based resin layer, a non-thermoplastic polyimide-based resin layer, and a thermoplastic polyimide-based resin layer.

In an embodiment, the metal layer may include at least one of copper, aluminum, and stainless steel (SUS).

In an embodiment, the metal layer may be in the form of a thin film. In an embodiment, a storage modulus of the thermoplastic polyimide-based resin layer measured at 350° C. may be 1.0×10⁸ Pa or less, and a difference in a coefficient of thermal expansion, measured at a temperature between 100° C. and 380° C., between the polyesterimide resin layer and the thermoplastic polyimide-based resin layer may be 100 ppm/K or less.

The thermoplastic polyimide-based resin layer may be a resin of Chemical Formula 4 including an imide group in a repeating unit, and a composition of a resin having a storage modulus of 1×10⁸ Pa or less measured at 350° C. using a dynamic mechanical analysis (DMA) is not particularly restricted.

A thermoplastic polyimide resin in the insulating layer of the flexible metal foil laminate may be a polyimide-based resin that may be used to laminate the insulating layer and a metal foil by applying heat and pressure, and a composition of the thermoplastic polyimide resin is not particularly limited as long as the thermoplastic polyimide resin has a storage modulus of 1.0×10⁸ Pa or less measured at 350° C. However, if the storage modulus of the thermoplastic polyimide resin measured at 350° C. exceeds 1.0×10⁸ Pa, lamination with the metal foil may be impossible due to a lack of flow properties at a high temperature. In other words, the storage modulus of the thermoplastic polyimide resin measured at 350° C. may need to be 1.0×10⁸ Pa or less.

A thermoplastic polyimide-based resin according to an embodiment may be stacked with a polyesterimide-based resin layer to form an insulating layer of a flexible metal foil laminate. A polyesterimide-based resin with the structure of Chemical Formula 1 may have a small amount of expansion at a high temperature due to its high crystallinity. Accordingly, delamination between the polyesterimide-based resin layer and the thermoplastic polyimide-based resin layer may easily occur due to a difference in the coefficient of thermal expansion at a high temperature when the polyesterimide-based resin layer and typical thermoplastic polyimide-based resin layers are laminated. Due to the delamination, an adhesion to a copper foil may decrease and exterior defects may easily occur in a manufacturing process of the flexible metal foil laminate.

Therefore, a difference in the amount of expansion at a high temperature between the thermoplastic polyimide-based resin layer and the polyesterimide-based resin layer may need to be low. A difference in a coefficient of linear thermal expansion, measured at a temperature between 100° C. and 350° C., between a polyesterimide resin layer and a thermoplastic polyimide resin layer included in the flexible metal foil laminate may be 100 ppm/K or less.

In an embodiment, a surface roughness Rz of the metal layer in contact with the insulating layer may be less than or equal to 1.5 m, and a bonding strength between the metal layer and the insulating layer may be greater than or equal to 0.8 kilogram force per centimeter (kgf/cm).

A flexible copper foil-laminated film according to an embodiment may be included in a flexible printed circuit board (FPCB). The FPCB may be an electronic component that is developed as electronic products become miniaturized and light-weighted. The FPCB including the flexible copper foil-laminated film may have excellent physical properties.

The FPCB may be used as a core component of an electronic product, in a device including at least one of a mobile phone, a camera, a laptop, a wearable device, a computer and peripheral devices, a mobile communication terminal, a video/audio device, a camcorder, a printer, a digital versatile disc (DVD) player, a thin film transistor liquid crystal display (TFT LCD) device, satellite equipment, military equipment, and medical equipment. Desirably, the FPCB may be used in at least one of a mobile phone, a camera, a laptop, and a wearable device.

According to an embodiment, a method of preparing a polyesterimide resin composition may include preparing a polyamic acid through a reaction between a diamine and a dianhydride, and thermally or chemically converting the polyamic acid.

In an embodiment, the polyesterimide resin composition may be a compound having a structural unit represented by Chemical Formula 1:

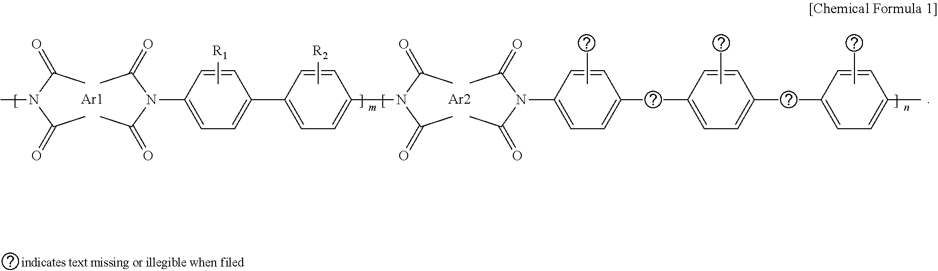

In Chemical Formula 1, m and n are mole fractions, and “m+n=1”, “0.2≤m≤0.8”, and “0.2≤n≤0.8” are satisfied. Ar1 and Ar2 are the same as or different from each other and are each independently a tetravalent organic group having at least one aromatic ring. R₁, R₂, and R₄ to R₆ each independently include at least one of —H, —F, —CH₃, —OCH₃, —CF₃, and —OCF₃. R₃ is an ester group and includes —COO— or —OOC—.

In an embodiment, the preparing of the polyamic acid may include preparing the polyamic acid through the reaction between the diamine and the dianhydride.

In an embodiment, the preparing of the polyamic acid may include dissolving the diamine in an organic solvent or dispersing the diamine in the form of slurry in an inert atmosphere, and adding the dianhydride that is dissolved in the organic solvent or dispersed in the form of slurry or adding the dianhydride in a solid state.

In an embodiment, an organic solvent used to synthesize a precursor solution of a polyesterimide resin may include all solvents in which a precursor of the polyesterimide resin is dissolved, without being particularly limited thereto. The organic solvent may include, for example, a sulfoxide-based solvent such as dimethyl sulfoxide and diethyl sulfoxide, a formamide-based solvent such as N,N-dimethylformamide and N,N-diethylformamide, an acetamide-based solvent such as N,N-dimethylacetamide, N,N-diethylacetamide, a pyrrolidone-based solvent such as N-methyl-2-pyrrolidone and N-vinyl-2-pyrrolidone, a phenol-based solvent such as phenol, o-, m-, or p-cresol, xylenol, halogenated phenol, and catechol, an ether-based solvent such as diglyme, triglyme, tetraglyme, tetrahydrofuran, and dioxane, an alcohol-based solvent such as methanol, ethanol, and butanol, a cellosolve-based solvent such as butyl cellosolve, or hexamethylphosphoramide, γ-butyrolactone, and the like. The above solvents may desirably be used independently or as a mixture. However, aromatic hydrocarbon such as xylene and toluene may also be used.

In an embodiment, the diamine may include, but is not limited to, at least one of aromatic diamine, such as p(para)-phenylenediamine, m-phenylenediamine, 4,4′-diaminodiphenylmethane, 4,4′-diaminodiphenylethane, 4,4′-diaminodiphenyl ether, 4,4′-diaminophenyl sulfide, 4,4′-diaminophenyl sulfone, 1,5-diaminonaphthalene, 3,3-dimethyl-4,4′-diaminobiphenyl, 3,5-diamino-benzoic acid, 5-amino-1-(4′-aminophenyl)-1,3,3-trimethyl indane, 6-amino-1-(4′-aminophenyl)-1,3,3-trimethyl indane, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminophenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4-bis(4-aminophenoxy)-biphenyl, 1,3-bis(4-aminophenoxy)benzene, 9,9-bis(4-aminophenyl)fluorene, 4,4′-(p-phenyleneisopropylidene)bisaniline, 4,4′(m-phenyleneisopropylidene)bisaniline, 4,4′-oxydianiline, 2,2′-bis[4-(4-amino-2-trifluoromethylphenoxy)phenyl]hexafluoropropane, 4,4′-bis[4-(4-amino-2-trifluoromethyl)phenoxy]-octafluorophenyl, etc.; an aromatic diamine having two amino groups bonded to an aromatic ring and having a heteroatom other than nitrogen atom of the amino group, such as diaminotetraphenylthiophene; and an aliphatic diamine and an alicyclic diamine, such as 1,1-metaxylylenediamine, 1,3-propanediamine, tetramethylenediamine, pentamethylenediamine, octamethylenediamine, nonamethylenediamine, 4,4-diaminoheptane methylenediamine, 1,4-diaminocyclohexane, isophoronediamine, tetrahydrodicyclopentadienylenediamine, hexahydro-4,7-methanoindanylenedimethylenediamine, and 4,4′-methylenebis(cyclohexylamine).

In an embodiment, the diamine may desirably include at least one of 4,4′-diamino-3,3′-dimethylbiphenyl (o-tolidine, CAS No. 119-93-7), 4,4′-diamino-2,2′-dimethylbiphenyl (m-tolidine, CAS No. 84-67-3), 2,2′-bis(trifluoromethyl)benzidine (22TFMB, CAS No. 341-58-2), 3,3′-bis(trifluoromethyl)benzidine (33TFMB, CAS No. 346-88-3), 1,4-phenylene-di-4-aminobenzoate (ABHQ, CAS No. 22095-98-3), and bis(4-aminophenyl)terephthalate (BPTP, CAS No. 16926-73-1).

In an embodiment, the dianhydride may include at least one of: an aliphatic or alicyclic tetracarboxylic dianhydride including at least one of 2,2′-hexafluoropropylidene diphthalic dianhydride, 2,2-bis(4-hydroxyphenyl)propane dibenzoate-3,3′,4,4′-tetracarboxylic dianhydride, butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofuran tetracarboxylic dianhydride, 5-(2,5-dioxotetrahydrofural)-3-methyl-3-cyclohexene-1,2-dicarboxylic dianhydride, and bicyclo[2,2,2]-oct-7-ene-2,3,5,6-tetracarboxylic dianhydride; and at least one aromatic tetracarboxylic dianhydride among pyromellitic dianhydride, 3,3′, 4,4′-benzophenonetetracarboxylic dianhydride, 3,3′, 4,4′-biphenylsulfonetetracarboxylic dianhydride, 1,4,5,8-naphthalenetetracarboxylic dianhydride, 2,3,6,7-naphthalenetetracarboxylic dianhydride, 3,3′, 4,4′-biphenyl ether tetracarboxylic dianhydride, 3,3′, 4,4′-dimethyldiphenylsilanetetracarboxylic dianhydride, 3,3′, 4,4′-tetraphenylsilanetetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bisphenol A dianhydride, 3,3′, 4,4′-perfluoroisopropylidenediphthalic dianhydride, 3,3′, 4,4′-biphenyltetracarboxylic dianhydride, bis(phthalic acid)phenylphosphine oxide dianhydride, p-phenylene-bis(triphenyl phthalic) dianhydride, m-phenylene-bis(triphenyl phthalic) dianhydride, bis(triphenyl phthalic)-4,4′-diphenyl ether dianhydride, 3,3′,4,4′-benzophenonetetracarboxylic dianhydride, and bis(triphenyl phthalic)-4,4′-diphenylmethane dianhydride.

In an embodiment, the inert atmosphere may include at least one inert gas among argon, nitrogen, and helium.

In an embodiment, the thermally converting of the polyamic acid may include converting the polyamic acid into polyimide through a heat treatment at a relatively high temperature.

In an embodiment, the chemically converting of the polyamic acid may include converting the polyamic acid into polyimide through a treatment with chemicals using an anhydride and a catalyst.

According to an embodiment, a method of preparing a polyesterimide resin composition may include directly reacting a dianhydride and diisocyanate. The polyesterimide resin composition may include a compound having a structural unit represented by Chemical Formula 1:

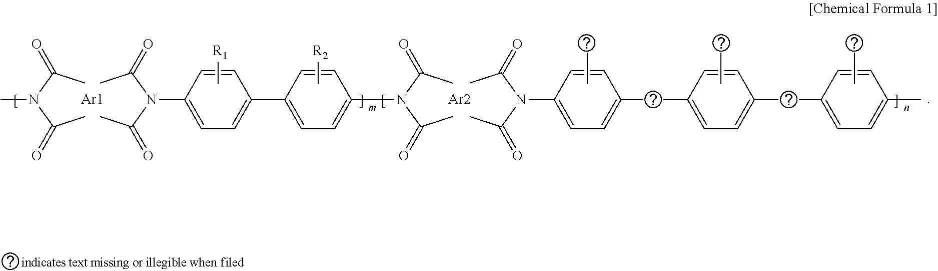

In Chemical Formula 1, m and n are mole fractions, and “m+n=1”, “0.2≤m≤0.8” and “0.2≤n≤0.8” are satisfied, Ar1 and Ar2 are the same as or different from each other and are each independently a tetravalent organic group having at least one aromatic ring, R₁, R₂, and R₄ to R₆ each independently include at least one of —H, —F, —CH₃, —OCH₃, —CF₃, and —OCF₃, and R₃ is an ester group and includes —COO— or —OOC—.

In an embodiment, the directly reacting of the dianhydride and the diisocyanate may be a method of directly preparing a polyimide instead of using a polyamic acid.

In an embodiment, the dianhydride may include at least one of: an aliphatic or alicyclic tetracarboxylic dianhydride including at least one of 2,2′-hexafluoropropylidene diphthalic dianhydride, 2,2-bis(4-hydroxyphenyl)propane dibenzoate-3,3′, 4,4′-tetracarboxylic dianhydride, butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofuran tetracarboxylic dianhydride, 5-(2,5-dioxotetrahydrofural)-3-methyl-3-cyclohexene-1,2-dicarboxylic dianhydride, and bicyclo[2,2,2]-oct-7-ene-2,3,5,6-tetracarboxylic dianhydride; and at least one aromatic tetracarboxylic dianhydride among pyromellitic dianhydride, 3,3′, 4,4′-benzophenonetetracarboxylic dianhydride, 3,3′, 4,4′-biphenylsulfonetetracarboxylic dianhydride, 1,4,5,8-naphthalenetetracarboxylic dianhydride, 2,3,6,7-naphthalenetetracarboxylic dianhydride, 3,3′, 4,4′-biphenyl ether tetracarboxylic dianhydride, 3,3′, 4,4′-dimethyldiphenylsilanetetracarboxylic dianhydride, 3,3′, 4,4′-tetraphenylsilanetetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bisphenol A dianhydride, 3,3′, 4,4′-perfluoroisopropylidenediphthalic dianhydride, 3,3′, 4,4′-biphenyltetracarboxylic dianhydride, bis(phthalic acid)phenylphosphine oxide dianhydride, p-phenylene-bis(triphenyl phthalic) dianhydride, m-phenylene-bis(triphenyl phthalic) dianhydride, bis(triphenyl phthalic)-4,4′-diphenyl ether dianhydride, 3,3′, 4,4′-benzophenonetetracarboxylic dianhydride, and bis(triphenyl phthalic)-4,4′-diphenylmethane dianhydride.

In an embodiment, the diisocyanate may include diisocyanate containing siloxane, and diisocyanate free of siloxane.

According to an embodiment, a method of preparing a polyesterimide film may include applying a polyamic acid-based resin composition convertible into a polyesterimide resin onto a metal belt, forming a gel film by thermally or chemically imidizing the polyamic acid-based resin composition, and separating the gel film from the metal belt.

In an embodiment, the applying of the polyamic acid resin composition may include applying a polyamic acid-based resin composition convertible into a polyesterimide resin onto a metal belt.

In an embodiment, the metal belt may include at least one of copper, aluminum, or SUS.

In an embodiment, the polyamic acid-based resin composition convertible into the polyesterimide resin may be prepared by preparing the polyamic acid through the reaction between the diamine and the dianhydride, as described above in the method of preparing the polyesterimide resin composition.

In an embodiment, the thermally converting of the polyamic acid-based resin composition may include converting the polyamic acid into a polyesterimide resin through a heat treatment at a relatively high temperature.

In an embodiment, the chemically converting of the polyamic acid-based resin composition may include converting the polyamic acid into a polyesterimide resin through a treatment with chemicals using an anhydride and a catalyst.

In an embodiment, when the gel film is separated from the metal belt and an additional heat treatment is performed, the polyesterimide film may be formed.

According to an embodiment, a method of preparing a flexible metal foil laminate may include sequentially applying polyamic acid-based resin layers, which are respectively convertible into a thermoplastic polyimide-based resin layer, anon-thermoplastic polyimide-based resin layer, and a thermoplastic polyimide-based resin layer, onto a metal layer, and performing imidization by thermally or chemically converting the polyamic acid-based resin layers.

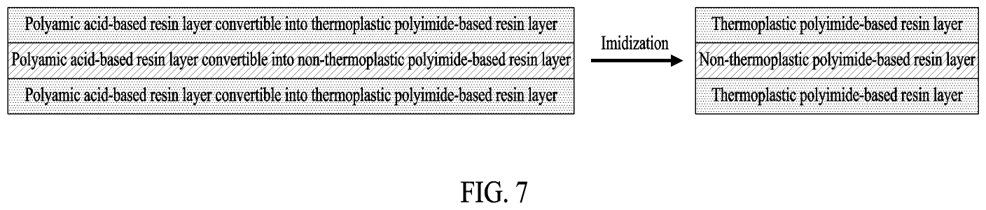

FIG. 7 is a diagram illustrating an example of a method of preparing a flexible metal foil laminate according to an embodiment.

Referring to FIG. 7, when a polyamic acid-based resin layer convertible into a thermoplastic polyimide-based resin layer, a polyamic acid-based resin layer convertible into a non-thermoplastic polyimide-based resin layer, and a polyamic acid-based resin layer convertible into a thermoplastic polyimide-based resin layer are stacked and imidized, the polyamic acid-based resin layers may be converted into a thermoplastic polyimide-based resin layer, a non-thermoplastic polyimide-based resin layer, and a thermoplastic polyimide-based resin layer, respectively.

In an embodiment, the polyamic acid-based resin layer convertible into the non-thermoplastic polyimide-based resin layer may be a polyamic acid-based resin layer convertible into a polyesterimide-based resin layer.

In an embodiment, the non-thermoplastic polyimide-based resin layer may be a polyesterimide-based resin layer.

In an embodiment, a metal layer may include at least one conductive metal among copper, aluminum, silver, palladium, nickel, chromium, molybdenum, and tungsten. The metal layer may also include an alloy or a mixture of conductive metals.

Desirably, the metal layer may be copper.

In an embodiment, to increase a bonding strength between the metal layer and the polyimide-based resin layer in contact with the metal layer, a physical or chemical surface treatment may be performed on a surface of the metal layer. According to an embodiment, a predetermined surface roughness may be provided to the surface of the metal layer by the physical or chemical surface treatment.

A surface of a metal layer in contact with an insulating layer in the flexible metal foil laminate may have a surface roughness Rz of 1.5 μm or less.

A difference in a coefficient of thermal expansion between the polyesterimide-based resin layer and the thermoplastic polyimide-based resin layer may need to be reduced. However, since a flowability at a high temperature typically decreases as the coefficient of thermal expansion of the thermoplastic polyimide-based resin decreases, a phenomenon of failing to completely satisfy a surface roughness of a metal foil may easily occur. Accordingly, to complement such a low flowability of a thermoplastic polyimide resin at a high temperature, a surface roughness Rz of a metal foil in the flexible metal foil laminate may need to be 1.5 μm or less. Thus, a flexible metal foil laminate in which a bonding strength between the metal foil and the insulating layer is greater than or equal to 0.8 kgf/cm may be prepared. In addition, as the surface roughness of the metal foil decreases, a transmission loss of a signal flowing along a circuit may decrease.

In an embodiment, in the sequentially applying of the polyamic acid-based resin layers, which are respectively convertible into the thermoplastic polyimide-based resin layer, the non-thermoplastic polyimide-based resin layer, and the thermoplastic polyimide-based resin layer, knife coating, roll coating, die coating, or curtain coating methods may be used. As a coating solution, a pre-cured (semi-cured) polyimide solution or a fully cured polyimide solution as well as a polyimide precursor solution may be used.

In an embodiment, a polyesterimide resin composition according to an embodiment may be applied onto the thermoplastic polyimide-based resin layer and then dried, to form a polyesterimide resin layer.

According to an embodiment, a method of preparing a flexible metal foil laminate may include preparing a multilayer polyimide film including a multilayer structure formed by a thermoplastic polyimide-based resin layer, a non-thermoplastic polyimide-based resin layer, and a thermoplastic polyimide-based resin layer, and laminating a metal layer on one surface or both surfaces of the multilayer polyimide film.

In an embodiment, the non-thermoplastic polyimide-based resin layer may be a polyesterimide-based resin layer.

In an embodiment, a precursor resin convertible into a thermoplastic polyimide-based resin layer may be applied onto both surfaces of a non-thermoplastic polyimide film, and a heat treatment may be performed, to form the multilayer polyimide film including the multilayer structure formed by the thermoplastic polyimide-based resin layer, the non-thermoplastic polyimide-based resin layer, and the thermoplastic polyimide-based resin layer.

In an embodiment, a polyesterimide resin composition according to an embodiment may be applied onto the thermoplastic polyimide-based resin layer and then dried, to form a polyesterimide resin layer.

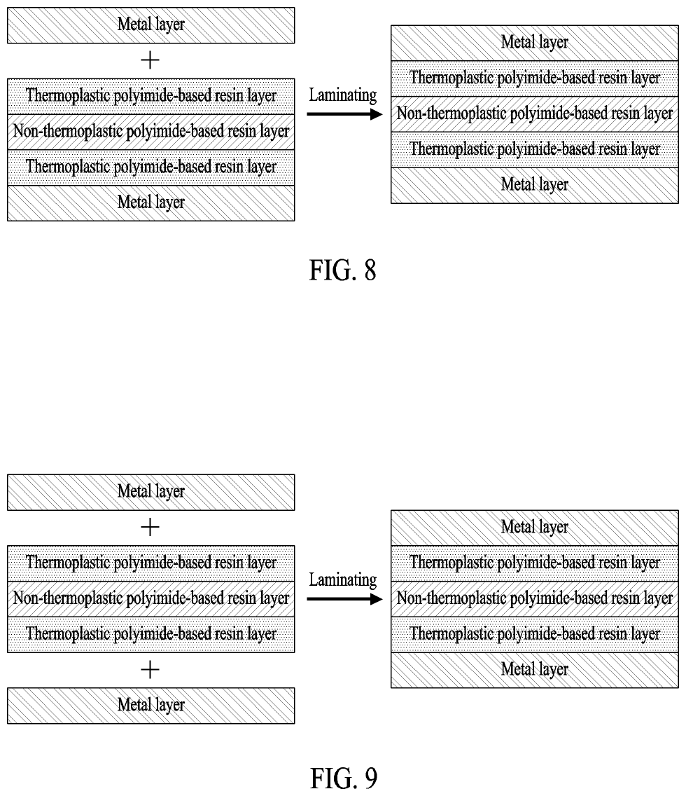

FIG. 8 is a drawing illustrating another example of a method of preparing a flexible metal foil laminate according to an embodiment.

Referring to FIG. 8, a method of preparing a double-sided flexible metal foil laminate according to an embodiment may be used to prepare a double-sided flexible metal foil laminate by laminating a metal layer on one side opposite to a multilayer polyimide film formed on another metal layer. The multilayer polyimide film may include a multilayer structure formed by a thermoplastic polyimide-based resin layer, a non-thermoplastic polyimide-based resin layer, and a thermoplastic polyimide-based resin layer.

FIG. 9 is a drawing illustrating another example of a method of preparing a flexible metal foil laminate according to an embodiment.

Referring to FIG. 9, in a method of preparing a double-sided flexible metal foil laminate according to an embodiment, two metal layers, and a multilayer polyimide film may be separately prepared, and the metal layers may be laminated onto both surfaces of the multilayer polyimide film, respectively, to prepare a double-sided flexible metal foil laminate. The multilayer polyimide film may include a multilayer structure formed by a thermoplastic polyimide-based resin layer, a non-thermoplastic polyimide-based resin layer, and a thermoplastic polyimide-based resin layer.

Hereinafter, the present disclosure will be described in detail with reference to the following examples, comparative examples, preparation examples, and comparative preparation examples. However, the technical idea of the present disclosure is not limited or restricted thereto.

Abbreviations used in the following examples, comparative examples, preparation examples, and comparative preparation examples are as follows:
DMAc: N,N-dimethylacetamide
PMDA: pyromellitic dianhydride
BPDA: 3,3′,4,4′-biphenyltetracarboxylic dianhydride
m-TD: m-tolidine
BPTP: bis(4-aminophenyl)terephthalate
TPE-R: 1,3-bis(4-aminophenoxy)benzene
BAPP: 2,2-bis[4-(4-aminophenoxy)phenyl]propane

The physical properties described herein were measured by the following methods.

### (1) Measurement of Dielectric Loss Tangent

An insulating layer was cut into 8 cm squares and pre-treated for 24 hours in a thermo-hygrostat at 23° C. and 50% RH to absorb moisture, and then the dielectric loss tangent was measured at 10 GHz using a split post dielectric resonator (SPDR) method.

### (2) Measurement of Moisture Absorption Rate

An insulating layer was cut into 5 cm squares. The cut specimen was dried in a convection oven at 150° C. for 1 hour or greater, and a mass of the dried specimen was measured and defined as a dry weight W₁. The specimen with the measured dry weight was pre-treated for 24 hours in a thermo-hygrostat at 23° C. and 50% RH to absorb moisture, and the mass of the specimen was measured and defined as a weight W₂ after absorbing moisture. Based on the measured values, a calculation was performed by substituting the values into Expression 1 below.

$$\frac{{W}_{2} - {W}_{1}}{{W}_{1}} \times 100 \qquad [ Expression 1 ]$$

### (3) Measurement of Coefficient of Linear Thermal Expansion

A coefficient of linear thermal expansion was measured while the temperature was raised from 30° C. to 400° C. at a rate of 10° C. per minute in a nitrogen atmosphere with a tension of 0.03 N using a TMA7100 model available from Hitachi. The average coefficient of linear thermal expansion measured at a temperature between 100° C. and 250° C. among the measured values was defined as a coefficient of linear thermal expansion at the temperature between 100° C. and 250° C.

### (4) Measurement of Storage Modulus

A storage modulus was measured by increasing the temperature from 30° C. to 400° C. at a rate of 5° C. per minute in a nitrogen atmosphere, under conditions of a tensile force of 0.1 N, a frequency of 10 Hz, and displacement of 30 μm, using a DMA7100 model available from Hitachi.

### (5) Evaluation of Film Formation Properties

When the same portion of an insulating layer is folded repeatedly three times at an angle of 180°, when visible cracks or tears are absent in the insulating layer, the film formation properties were determined to be good, and when visible cracks or tears are present, the firm formation properties were determined to be poor.

### (6) Measurement of Surface Roughness of Matt Side of Metal Foil

A surface of a matt side of a metal foil was measured in accordance with JIS1994.

### (7) Evaluation of Adhesion to Metal Foil

To measure an adhesion (peel strength) between an insulating layer and a metal layer of a flexible metal foil laminate, the metal layer was patterned to have a width of 1 millimeter (mm) and then a 180° peel strength thereof was measured using a universal testing machine (UTM). The other properties were measured in accordance with JIS C6471.

### Example 1

After m-TD and BPTP were slowly dissolved in DMAc in a molar ratio of 82:20 at room temperature, 50 mol % of BPDA and 50 mol % PMDA were added in several portions to 102 mol % of the total diamine, to prepare a mixture. The mixture was reacted at room temperature for 24 hours, to prepare a precursor solution of a polyesterimide resin. Here, a solid content of a monomer in the total solution including the monomer and DMAc was 13% by weight (wt %).

Subsequently, the precursor solution prepared by the above method was applied onto an electrolytic copper foil with a thickness of 12 m to have a thickness of 20 m after a final heat treatment, and then dried in a hot air dryer at 140° C. for 10 minutes, to form a precursor layer. A heat treatment was performed on a precursor film applied onto the copper foil in a nitrogen atmosphere for eight minutes at a temperature of 130° C. to 395° C. together with the copper foil, to imidize a precursor layer on the copper foil. The copper foil was removed from a laminate of the copper foil and polyesterimide resin through chemical etching, a polyesterimide resin layer was obtained, and physical properties of a corresponding film were measured and are shown in Table 2.

### Examples 2 Through 5 and Comparative Examples 1 Through 3

Precursor solutions were obtained in the same manner as in Example 1 according to ingredients and amounts shown in Table 1.

Subsequently, resin films were obtained in the same manner as in Example 1, and physical properties thereof are shown in Table 2.

TABLE 1

| | Dianhydride 1 | Dianhydride 2 | Diamine 1 | Diamine 2 |
|---|---|---|---|---|
| Classification | (mol %) | (mol %) | (mol %) | (mol %) |
| Example 1 | BPDA(50) | PMDA(50) | m-TD(82) | BPTP(20) |
| Example 2 | BPDA(60) | PMDA(40) | m-TD(62) | BPTP(40) |
| Example 3 | BPDA(100) | — | m-TD(62) | BPTP(40) |
| Example 4 | BPDA(50) | PMDA(50) | m-TD(22) | BPTP(80) |
| Example 5 | BPDA(100) | — | m-TD(22) | BPTP(80) |
| Comparative | BPDA(100) | — | — | BPTP(102) |
| Example 1 | | | | |
| Comparative | BPDA(50) | PMDA(50) | — | BPTP(102) |
| Example 2 | | | | |
| Comparative | BPDA(100) | — | m-TD(102) | — |
| Example 3 | | | | |

TABLE 2

| | Dielectric loss | Moisture | | |
|---|---|---|---|---|
| | tangent | absorption rate | CTE | Firm formation |
| Examples | (Df) | (%) | (100~250° C.) | properties |
| Example 1 | 0.0032 | 0.46 | 21.4 | Good |
| Example 2 | 0.0027 | 0.39 | 25.6 | Good |
| Example 3 | 0.0023 | 0.38 | 20.5 | Good |
| Example 4 | 0.0025 | 0.45 | 44.3 | Good |
| Example 5 | 0.0029 | 0.46 | 12.2 | Good |
| Comparative | 0.0034 | 0.38 | — | Poor |
| Example 1 | | | | |
| Comparative | 0.0038 | 0.34 | — | Poor |
| Example 2 | | | | |
| Comparative | 0.0054 | 0.65 | 10.5 | Good |
| Example 3 | | | | |

Referring to Table 2, it can be confirmed that polyesterimide resin layers according to Examples 1 to 5 have low dielectric loss tangents (i.e., a dielectric loss tangent of “0.0032” or less), low moisture absorption rates (i.e., 0.46% or less), low coefficients of thermal expansion (CTE) (i.e., 50 ppm/K or less) in comparison to Comparative Examples 1 to 3, and have good film formation properties.

It can be confirmed that polyesterimide resin layers according to Comparative Examples 1 to 3 have high dielectric loss tangents, i.e., “0.0034” or greater, and that measurement of CTE was impossible and film formation properties were poor in Comparative Examples 1 and 2. In addition, it can be confirmed that an excessively high dielectric loss tangent and an excessively high moisture absorption rate were observed in Comparative Example 3.

### Preparation of Thermoplastic Polyimide Resin

### Example 6

After TPE-R was slowly dissolved in DMAc at room temperature, 101 mol % of BPDA was added in several portions to 100 mol % of the total diamine, to prepare a mixture. The mixture was reacted at room temperature for 24 hours. Here, a solid content of a monomer in the total solution including the monomer and DMAc was 10 wt %, to prepare a precursor solution.

Subsequently, the precursor solution prepared by the above method was applied onto an electrolytic copper foil with a thickness of 12 m to have a thickness of 20 m after a final heat treatment, and then dried in a hot air dryer at 140° C. for 10 minutes, to form a precursor layer. A heat treatment was performed on a precursor film applied onto the copper foil in a nitrogen atmosphere for eight minutes at a temperature of 130° C. to 395° C. together with the copper foil, to imidize a precursor layer on the copper foil. The copper foil was removed from a laminate of the copper foil and a polyesterimide resin through chemical etching, a polyesterimide resin layer was obtained, and physical properties of a corresponding film were measured.

### Example 7 and Comparative Examples 5 and 6

Precursor solutions were obtained in the same manner as in Example 6 according to ingredients and amounts shown in Table 3.

Subsequently, resin films were obtained in the same manner as in Example 6, and physical properties thereof were measured.

TABLE 3

| | | | | | Storage |
|---|---|---|---|---|---|
| | Dianhydride 1 | Dianhydride 2 | Diamine 1 | Diamine 2 | modulus (Pa) |
| Classification | (mol %) | (mol %) | (mol %) | (mol %) | at 350° C. |
| Example 6 | BPDA(101) | — | TPE-R(100) | — | 1.2 × 10⁷ |
| Example 7 | BPDA(101) | — | TPE-R(40) | m-TD(60) | 2.1 × 10⁷ |
| Comparative | BPDA(91) | PMDA(10) | TPER(40) | m-TD(60) | 1.0 × 10⁷ |
| Example 5 | | | | | |
| Comparative | PMDA(101) | — | BAPP(100) | — | 6.8 × 10⁷ |
| Example 6 | | | | | |

### Preparation of Flexible Metal Foil Laminate

### Preparation Example 1

A thermoplastic polyimide resin prepared according to Example 6 was applied onto an electrolytic copper foil having a thickness of 12 m and a surface roughness Rz of 1.0 μm to have a thickness of 3.0 m after a final heat treatment and dried at 140° C., to form a first thermoplastic polyimide resin layer.

Subsequently, a polyesterimide resin layer prepared according to Example 2 was applied onto the first thermoplastic polyimide resin layer to have a thickness of 19 m after a final heat treatment and dried at 140° C., to form a polyesterimide resin layer.

Subsequently, the thermoplastic polyimide resin prepared according to Example 6 was applied onto the polyesterimide resin layer to have a thickness of 3.0 m after a final heat treatment and dried at 140° C., to form a second thermoplastic polyimide resin layer. A heat treatment was performed on a precursor film applied onto the copper foil in a nitrogen atmosphere for eight minutes at a temperature of 130° C. to 395° C. together with the copper foil, to imidize a precursor layer on the copper foil. Properties of the flexible metal foil laminate prepared as described above are shown in Table 4 below.

### Preparation Example 2

A flexible metal foil laminate was prepared in the same manner as in Preparation Example 1 according to a layer structure described in Table 4.

### Comparative Preparation Examples 1 and 2

Flexible metal foil laminates were prepared in the same manner as in Preparation Example 1 according to the layer structure described in Table 4.

TABLE 4

| | | Difference *1) in | Adhesion to |
|---|---|---|---|
| | | coefficient of | Copper Foil |
| Classification | Layer structure | thermal expansion | (kgf/cm) |
| Preparation | Copper foil/Example 6/Example | 3 | 1.24 |
| Example 1 | 2/Example 6 | | |
| Preparation | Copper foil/Example 7/Example | 12 | 1.19 |
| Example 2 | 2/Example 7 | | |
| Comparative | Copper foil/Comparative Example | 837 | 0.57 |
| Preparation | 5/Example 2/Comparative Example 5 | | |
| Example 1 | | | |
| Comparative | Copper foil/Comparative Example | 190 | 0.86 |
| Preparation | 6/Example 2/Comparative Example 6 | | |
| Example 2 | | | |

*1) Difference in coefficient of thermal expansion (unit: ppm/K), measured at a temperature between 100° C. to 350° C., between a thermoplastic polyimide resin layer and a polyesterimide resin layer

Referring to Table 4, it is confirmed that a difference in the coefficient of thermal expansion between the flexible metal foil laminates according to Preparation Examples 1 and 2 is “12” or less, which is significantly different from a difference in the coefficient of thermal expansion between the flexible metal foil laminates according to Comparative Preparation Examples 1 and 2 which is “190” or greater.

In addition, it is confirmed that the adhesion to the copper foil in the flexible metal foil laminates according to Preparation Examples 1 and 2 are 1.24 kgf/cm and 1.19 kgf/cm, respectively, which is significantly different from the adhesion to the copper foil in the flexible metal foil laminates according to Comparative Preparation Examples 1 and 2 which are 0.57 kgf/cm and 0.86 kgf/cm, respectively.

It is confirmed that the polyesterimide resin layer according to an embodiment may be used as an insulating layer of a flexible metal foil laminate due to a low moisture absorption, a low thermal expansion, and a low dielectric loss tangent of the polyesterimide resin layer.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A polyesterimide resin composition comprising:
a compound having a structural unit represented by Chemical Formula 1: 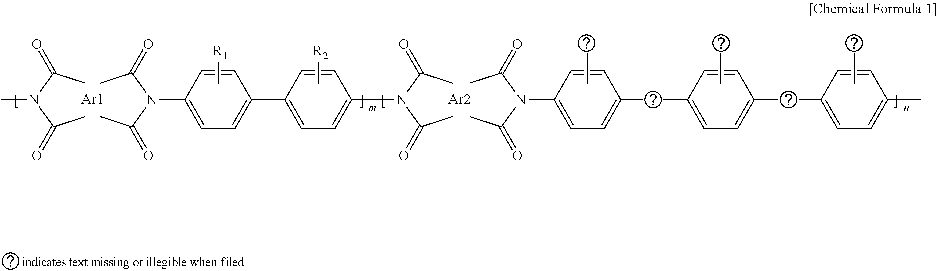
wherein, in Chemical Formula 1,
m and n are mole fractions,
“m+n=1”, “0.2≤m≤0.8”, and “0.2≤n≤0.8” are satisfied,
Ar1 and Ar2 are the same as or different from each other, and are each independently a tetravalent organic group having at least one aromatic ring,
R₁, R₂, and R₄ to R₆ each independently comprise at least one selected from a group consisting of —H, —F, —CH₃, —OCH₃, —CF₃, and —OCF₃, and
R₃ is an ester group and comprises —COO— or —OOC—.

2. The polyesterimide resin composition of claim 1, wherein Chemical Formula 1 comprises Chemical Formula 2:

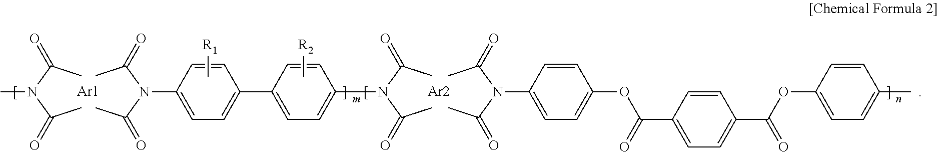

3. The polyesterimide resin composition of claim 1, wherein Ar1 and Ar2 in Chemical Formula 1 comprise a compound having a structural unit represented by Chemical Formula 3:

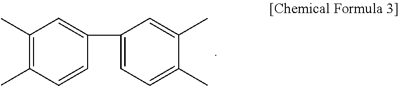

4. The polyesterimide resin composition of claim 3, wherein the compound having the structural unit represented by Chemical Formula 3 comprises at least 50 mol % of Ar1 and Ar2 in Chemical Formula 1.

5. A polyesterimide resin layer comprising:
the polyesterimide resin composition of claim 1,
wherein the polyesterimide resin layer has a dielectric loss tangent of “0.0035” or less at 10 gigahertz (GHz) measured at 23° C. and 50% relative humidity (RH).

6. A flexible metal foil laminate comprising:
at least one insulating layer; and
a metal layer formed on one surface or both surfaces of the insulating layer,
wherein the insulating layer comprises a polyesterimide resin layer comprising the polyesterimide resin composition of claim 1.

7. The flexible metal foil laminate of claim 6, wherein
the insulating layer further comprises at least one thermoplastic polyimide-based resin layer,
wherein the thermoplastic polyimide-based resin layer comprises a compound including an imide group represented by Chemical Formula 4: 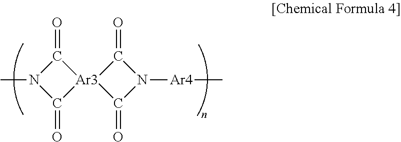
wherein, in Chemical Formula 4,
Ar3 is a tetravalent organic group having at least one aromatic ring in a structure of Ar3, and
Ar4 is an organic group having at least one aromatic ring in a structure of Ar4.

8. The flexible metal foil laminate of claim 7, wherein
a storage modulus of the thermoplastic polyimide-based resin layer measured at 350° C. is 1.0×10⁸ Pa or less, and
a difference in a coefficient of thermal expansion, measured at a temperature between 100° C. and 380° C., between the polyesterimide resin layer and the thermoplastic polyimide-based resin layer is 100 parts per million per Kelvin (ppm/K) or less.

9. The flexible metal foil laminate of claim 7, wherein
a surface roughness (Rz) of the metal layer in contact with the insulating layer is less than or equal to 1.5 micrometers (m), and
a bonding strength between the metal layer and the insulating layer is greater than or equal to 0.8 kilogram force per centimeter (kgf/cm).

10. A method of preparing a polyesterimide resin composition, the method comprising:
preparing a polyamic acid through a reaction between a diamine and a dianhydride; and
thermally or chemically converting the polyamic acid,
wherein the polyesterimide resin composition comprises a compound having a structural unit represented by Chemical Formula 1: 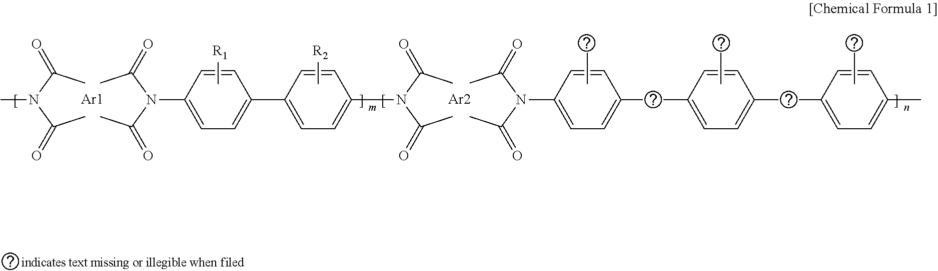
wherein, in Chemical Formula 1,
m and n are mole fractions,
“m+n=1”, “0.2≤m≤0.8”, and “0.2≤n≤0.8” are satisfied,
Ar1 and Ar2 are the same as or different from each other and are each independently a tetravalent organic group having at least one aromatic ring,
R₁, R₂, and R₄ to R₆ each independently comprise at least one selected from a group consisting of —H, —F, —CH₃, —OCH₃, —CF₃, and —OCF₃, and
R₃ is an ester group and comprises —COO— or —OOC—, and
wherein the diamine comprises at least one selected from a group consisting of 4,4′-diamino-3,3′-dimethylbiphenyl (o-tolidine, CAS No. 119-93-7), 4,4′-diamino-2,2′-dimethylbiphenyl (m-tolidine, CAS No. 84-67-3), 2,2′-bis(trifluoromethyl)benzidine (22TFMB, CAS No. 341-58-2), 3,3′-bis(trifluoromethyl)benzidine (33TFMB, CAS No. 346-88-3), 1,4-phenylene-di-4-aminobenzoate (ABHQ, CAS No. 22095-98-3), and bis(4-aminophenyl)terephthalate (BPTP, CAS No. 16926-73-1).

11. The method of claim 10, wherein the dianhydride comprises at least one selected from a group consisting of:
an aliphatic or alicyclic tetracarboxylic dianhydride comprising at least one selected from a group consisting of 2,2′-hexafluoropropylidene diphthalic dianhydride, 2,2-bis(4-hydroxyphenyl)propane dibenzoate-3,3′, 4,4′-tetracarboxylic dianhydride, butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofuran tetracarboxylic dianhydride, 5-(2,5-dioxotetrahydrofural)-3-methyl-3-cyclohexene-1,2-dicarboxylic dianhydride, and bicyclo[2,2,2]-oct-7-ene-2,3,5,6-tetracarboxylic dianhydride; and
at least one aromatic tetracarboxylic dianhydride selected from a group consisting of pyromellitic dianhydride, 3,3′, 4,4′-benzophenonetetracarboxylic dianhydride, 3,3′, 4,4′-biphenylsulfonetetracarboxylic dianhydride, 1,4,5,8-naphthalenetetracarboxylic dianhydride, 2,3,6,7-naphthalenetetracarboxylic dianhydride, 3,3′, 4,4′-biphenyl ether tetracarboxylic dianhydride, 3,3′, 4,4′-dimethyldiphenylsilanetetracarboxylic dianhydride, 3,3′, 4,4′-tetraphenylsilanetetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bisphenol A dianhydride, 3,3′, 4,4′-perfluoroisopropylidenediphthalic dianhydride, 3,3′, 4,4′-biphenyltetracarboxylic dianhydride, bis(phthalic acid)phenylphosphine oxide dianhydride, p-phenylene-bis(triphenyl phthalic) dianhydride, m-phenylene-bis(triphenyl phthalic) dianhydride, bis(triphenyl phthalic)-4,4′-diphenyl ether dianhydride, 3,3′, 4,4′-benzophenonetetracarboxylic dianhydride, and bis(triphenyl phthalic)-4,4′-diphenylmethane dianhydride.

12. A method of preparing a polyesterimide film, the method comprising:
applying a polyamic acid-based resin composition convertible into a polyesterimide resin onto a metal belt;
forming a gel film by thermally or chemically imidizing the polyamic acid-based resin composition; and
separating the gel film from the metal belt.
